(19) United States
(12) Patent Application Publication
(10) Pub. No.: US 2005/0086824 A1
(43) Pub. Date: Apr. 28, 2005

(54) Dryer

(76) Inventors: Koji Ono, Ora-gun (JP); Masahisa Otake, Ora-gun (JP); Masaya Tadano, Nitta-gun (JP); Etsushi Nagae, Ora-gun (JP); Hiroshi Mukaiyama, Ora-gun (JP)

Correspondence Address: MCDERMOTT WILL & EMERY LLP, 600 13th Street, N.W., Washington, DC, 20005-3096, US

(21) Appl. No.: 10/878,638

(22) Filed: Jun. 29, 2004

(30) Foreign Application Priority Data
Jun. 30, 2003 (JP) JP 2003-186916

(51) Int. Cl. F26B 19/00

(52) U.S. Cl. 34/62

(57) ABSTRACT

An object in a drier is to reduce a cooling time after completion of a drying operation and improve operation efficiency. The dryer comprises a storage room to accommodate a drying target and performs the drying operation and a cooling operation after completion of the drying operation for the drying target in the storage room. The dryer comprises: a refrigerant circuit configured by sequentially connecting, with a pipe in a circular form, a compressor, a radiator, a pressure reducing device, an evaporator and the like; an air circulation path for circulating, by an air blower, air from the radiator into the evaporator through the storage room; and an external radiator provided outside the air circulation path, wherein in the drying operation, a refrigerant discharged from the compressor flows to the radiator to release heat, and is pressure reduced by the pressure reducing device, and is then evaporated by the evaporator, and in the cooling operation, the refrigerant discharged from the compressor flows to the external radiator to release heat, and is pressure reduced by the pressure reducing device, and is then evaporated by the evaporator.

### BACKGROUND OF THE INVENTION

The present invention relates to a dryer which comprises a storage room to accommodate a drying target and which dries the drying target in the storage room.

Heretofore, a drier has used an electric heater or a gas combustion heater as a heat source, wherein air is heated by the electric heater or the combustion heater to produce high-temperature air, and the high-temperature air is blown into a storage room in which a drying target such as clothes is accommodated, thereby drying the drying target in the storage room. Then, the high-temperature air in the storage room which has dried the drying target is discharged outside.

However, in the drier using such an electric heater or gas combustion heater, as low-temperature humid air outside the storage room is used for the high-temperature air sent into the storage room, a long time is required until the drying target is dried. Therefore, energy consumption to dry the drying target is increased, leading to a problem of increased energy costs such as an electric bill and a gas bill.

Therefore, a clothes drier has been developed which uses a heat pump comprising a compressor, a heating coil, an expansion valve and a cooling coil to enable circulation of a heat exchange medium, wherein the drying target is dried with the high-temperature air heated by the heating coil while moisture evaporated from the drying target is condensed on the cooling coil and discharged (e.g., refer to Japanese Patent Publication Laid-open No. 11-99299).

By use of such a heat pump, it is possible to expect a reduction in time needed to dry the drying target and improvement in energy efficiency.

On the other hand, because the drying target heated and dried as described above is at high temperature, the drying target can not be taken out from the drier until it cools down. This cooling time is also included in the time needed to dry the clothes, but a relatively long cooling time has heretofore been required, so that a significant amount of time has been required until the drying target can be taken out after it is put in the dryer, leading to a desire for a shorter cooling time of the drying target.

### SUMMARY OF THE INVENTION

The present invention has been attained to solve such technical problems, and is intended, in a dryer, to reduce a cooling time after completion of a drying operation and improve operation efficiency.

More specifically, a dryer of the present invention comprises a storage room to accommodate a drying target and performs a drying operation and a cooling operation after completion of the drying operation for the drying target in the storage room. The dryer comprises: a refrigerant circuit configured by sequentially connecting, with a pipe in a circular form, a compressor, a radiator, a pressure reducing device, an evaporator and the like; an air circulation path for circulating, by air blowing means, air from the radiator into the evaporator through the storage room; and an external radiator provided outside the air circulation path. In the drying operation, refrigerant discharged from the compressor flows to the radiator to release heat, and is pressure reduced by the pressure reducing device, and is then evaporated by the evaporator. In the cooling operation, the refrigerant discharged from the compressor flows to the external radiator to release heat, and is pressure reduced by the pressure reducing device, and is then evaporated by the evaporator. Thus, in the drying operation, after the air is heated by the radiator, the air is discharged into the storage room to remove moisture from the drying target, and then the moisture removed by the evaporator is condensed, thereby enabling the drying target to be rapidly dried. In the cooling operation after completion of the drying operation, heating function in the radiator is stopped, and the air only cooled down by the evaporator can be discharged into the storage room.

This promotes the cooling of the drying target in the storage room after completion of the drying operation, and makes it possible to significantly reduce the time to be decreased to the temperature at which the drying target can be taken out.

Furthermore, a dryer of the present invention comprises a storage room to accommodate a drying target and performs a drying operation and a cooling operation after completion of the drying operation for the drying target in the storage room. The dryer comprises: a refrigerant circuit configured by sequentially connecting, with a pipe in a circular form, a compressor, a radiator, a pressure reducing device and an evaporator; and air blowing means for passing air to the radiator, into the storage room, and to the evaporator. In the drying operation, by the air blowing means, the air exchanges heat with the radiator and is then discharged into the storage room, and the air which has passed through the storage room exchanges heat with the evaporator. In the cooling operation, by the air blowing means, the air exchanges heat with the evaporator and is then discharged into the storage room, and the air which has passed through the storage room exchanges heat with the radiator. Thus, in the drying operation, after the air is heated by the radiator, the air is discharged into the storage room to remove moisture from the drying target, and then the moisture removed by the evaporator is condensed, thereby enabling the drying target to be rapidly dried. In the cooling operation after completion of the drying operation, the air cooled down by the evaporator can be discharged into the storage room.

This promotes the cooling of the drying target in the storage room after completion of the drying operation, and makes it possible to significantly reduce the time to be decreased to the temperature at which the drying target can be taken out. Especially, in this case, no specific external radiator and configuration are needed, so that costs can also be prevented from increasing.

Furthermore, a dryer of the present invention comprises a storage room to accommodate a drying target and performs a drying operation and a cooling operation after completion of the drying operation for the drying target in the storage room. The dryer comprises: a refrigerant circuit configured by sequentially connecting, with a pipe in a circular form, a compressor, a radiator, a pressure reducing device and an evaporator; an air circulation path for circulating air from the evaporator into the storage room through the radiator by air blowing means; and a bypass channel for circulating the air around the radiator. In the drying operation, the air is circulated through the air circulation path by the air blowing means, and in the cooling operation, the air is circulated from the evaporator into the storage room through the bypass channel by the air blowing means. Thus, in the drying operation, after the air is heated by the radiator, the air is discharged into the storage room to remove moisture from the drying target, and then the moisture removed by the evaporator is condensed, thereby enabling the drying target to be rapidly dried. In the cooling operation after completion of the drying operation, the air is circulated around the radiator through the bypass channel, and the air only cooled down by the evaporator can be discharged into the storage room.

This promotes the cooling of the drying target in the storage room after completion of the drying operation, and makes it possible to significantly reduce the time to be decreased to the temperature at which the drying target can be taken out.

Furthermore, a dryer of the present invention comprises a storage room to accommodate a drying target and performs a drying operation and a cooling operation after completion of the drying operation for the drying target in the storage room. The dryer comprises: a reversible refrigerant circuit constituted of a compressor, a first heat exchanger, a pressure reducing device, a second heat exchanger and the like; and air blowing means for causing air to exchange heat with the first heat exchanger and then to be discharged into the storage room, and causing the air which has passed through the storage room to exchange heat with the second heat exchanger. In the drying operation, refrigerant discharged from the compressor flows to the first heat exchanger to release heat, and is pressure reduced by the pressure reducing device, and is then evaporated by the second heat exchanger. In the cooling operation, the refrigerant discharged from the compressor flows to the second heat exchanger to release heat, and is pressure reduced by the pressure reducing device, and is then evaporated by the first heat exchanger. Thus, in the drying operation, after the first heat exchanger exerts heating function to heat the air, the air is discharged into the storage room to remove moisture from the drying target, and then the second heat exchanger exerts cooling function to condense the removed moisture, thereby enabling the drying target to be rapidly dried. In the cooling operation after completion of the drying operation, the first heat exchanger exerts the cooling function, and the air cooled down by the first heat exchanger can be discharged into the storage room.

This promotes the cooling of the drying target in the storage room after completion of the drying operation, and makes it possible to significantly reduce the time to be decreased to the temperature at which the drying target can be taken out. Especially, in this case, no specific external radiator and configuration are needed, so that costs can also be prevented from increasing.

### BRIEF DESCRIPTION OF THE DRAWINGS

FIG. 1 is an internal configuration diagram of a washer drier in a first embodiment of a drier of the present invention;

FIG. 2 is a diagram showing flow of a refrigerant and air in a drying operation of the washer drier in FIG. 1;

FIG. 3 is a diagram showing the flow of the refrigerant and air in a cooling operation of the washer drier in FIG. 1;

FIG. 4 is a diagram showing the flow of the refrigerant and air in the drying operation of the washer drier in a second embodiment of the drier of the present invention;

FIG. 5 is a diagram showing the flow of the refrigerant and air in the cooling operation of the washer drier in the second embodiment of the drier of the present invention;

FIG. 6 is a diagram showing the flow of the refrigerant and air in the drying operation of the washer drier in a third embodiment of the drier of the present invention;

FIG. 7 is a diagram showing the flow of the refrigerant and air in the cooling operation of the washer drier in the third embodiment of the drier of the present invention;

FIG. 8 is a diagram showing the flow of the refrigerant and air in the drying operation of the washer drier in a fourth embodiment of the drier of the present invention; and

FIG. 9 is a diagram showing the flow of the refrigerant and air in the cooling operation of the washer drier in the fourth embodiment of the drier of the present invention.

### DETAILED DESCRIPTION OF THE PREFERRED EMBODIMENT

### (1) First Embodiment

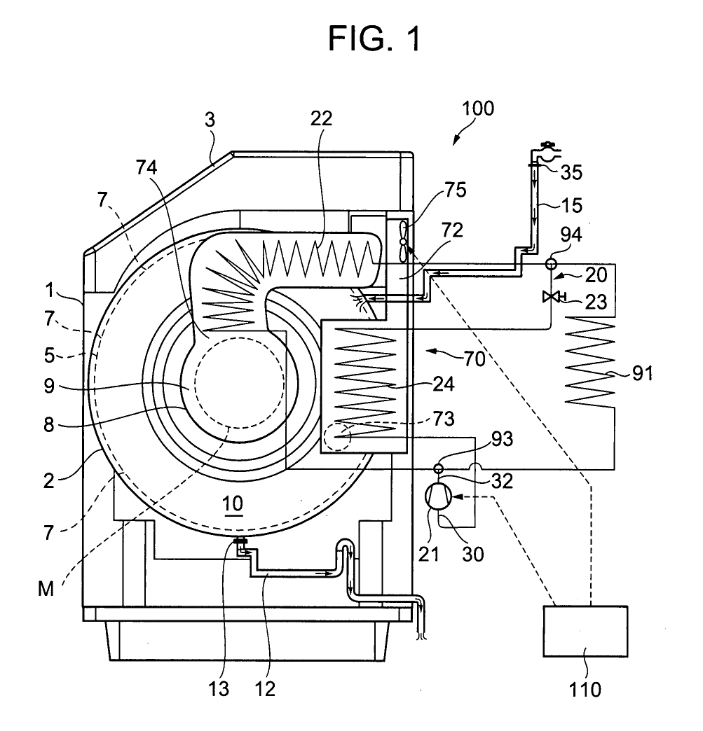

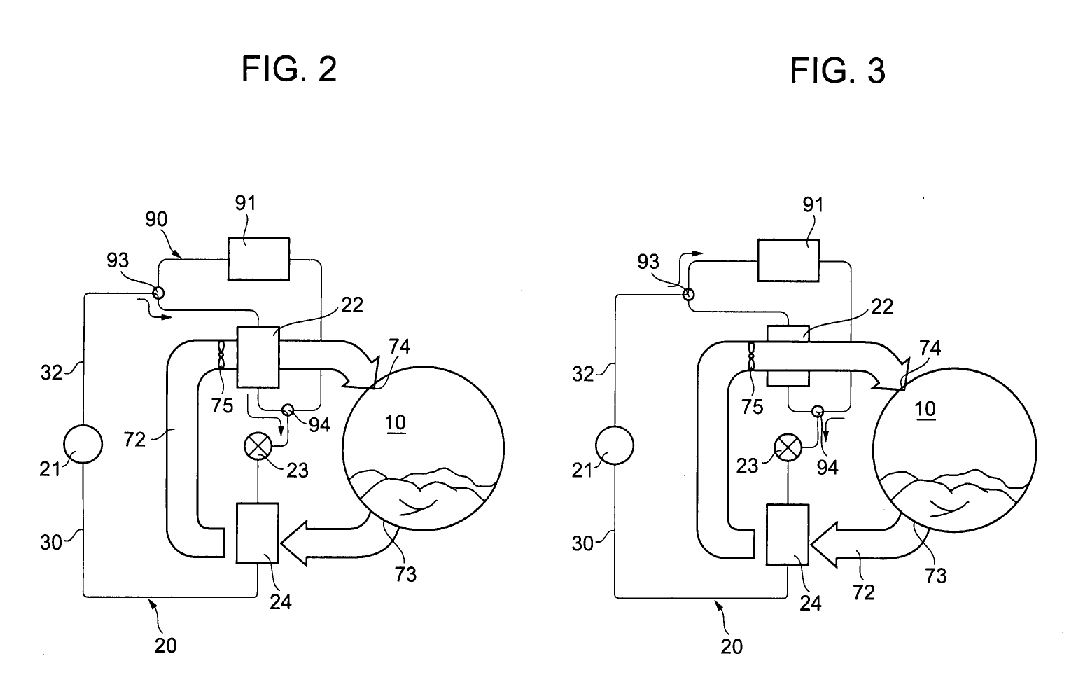

Next, embodiments of the present invention will be described in detail referring to the drawings. FIG. 1 is an internal configuration side view showing, as a first embodiment of a drier to which the present invention is applied, a washer drier 100 which performs, for example, a washing operation, a drying operation after completion of the washing operation, and a cooling operation after completion of the drying operation. FIG. 2 is a diagram showing flow of a refrigerant and air in the washer drier 100. The washer drier 100 is used to wash and dry a washing target (drying target) such as clothes. An open/close door 3 for letting in and out the washing target is attached to an upper central part of a main body 1 forming an outer shape. An unshown operation panel in which various kinds of operation switches and a display part are arranged is provided on an upper surface of the main body 1 on a lateral side of the open/close door 3.

A cylindrical stainless-steel external tub drum 2 capable of storing water is provided in the main body 1, and this external tub drum 2 is disposed to align a cylinder shaft in a lateral direction. Further, a cylindrical stainless-steel internal tub drum 5 serving as both a washing tub and a dewatering tub is provided inside the external tub drum 2. The inside of the internal tub drum 5 serves as a storage room 10 to accommodate the washing target, and this is also disposed to align a cylindrical shaft in the lateral direction. This shaft is coupled to a shaft 8 of a drive motor M mounted in a sidewall (far side of FIG. 1) of the main body 1, and held in the external tub drum 2 rotatably on the shaft 8.

An unshown watertight open/close cover for letting in and out the washing target is provided in an upper part of the external tub drum 2 so as to correspond to the open/close door 3. A large number of through-holes 7 through which air and water can flow are formed in a whole peripheral wall of the internal tub drum 5. Moreover, a stop position of the internal tub drum 5 is regulated, and the internal tub drum 5 has an unshown open/close cover for letting in and out the washing target at a position (upper surface) which corresponds to the open/close cover of the external tub drum 2 when the internal tub drum 5 is stopped.

The above-mentioned drive motor M is a motor to rotate the internal tub drum 5 on the shaft 8 in a lateral horizontal direction in the washing operation, the drying operation after completion of the washing operation, and the cooling operation after completion of the drying operation. This drive motor M is attached to one end of the shaft 8, and controlled by a controller 110 as control means described later in such a manner as to rotate the internal tub drum 5 at a lower speed in the drying operation and the cooling operation than in a dewatering process of the washing operation.

A hollow part 9 is formed within the other end of the shaft 8, and the inside of the internal tub drum 5 is in communication with an air circulation path 72 described later via the hollow part 9.

On the other hand, a water supply passage 15 as water supply means for supplying water into the internal tub drum 5 is provided in an upper part of the main body 1, and one end of the water supply passage 15 is connected to a supply source of water such as tap water via a water supply valve 35 which also constitutes the water supply means. The water supply valve 35 is opened and closed under the control of the controller 110. Further, the other end of the water supply passage 15 is connected to the external tub drum 2 to communicate with the inside of the external tub drum 2, and is configured in such a manner that water (tap water) is supplied from the water supply source to the storage room 10 in the internal tub drum 5 provided in the external tub drum 2 when the water supply valve 35 is opened by the controller 110.

Furthermore, a water discharge passage 12 as water discharge means for discharging water in the storage room 10 in the internal tub drum 5 is provided in a lower part of the main body 1, and one end of the water discharge passage 12 is in communication with a bottom part of the external tub drum 2 via a water discharge valve 13 (also constituting the water discharge means) which is opened and closed under the control of the controller 110. Moreover, the other end of the water discharge passage 12 is led to the outside of the washer drier 100 and reaches a drain or the like.

On the other hand, in the washer drier 100, a machine room 70 is configured from a lower side and/or rear side to a lateral side of the external tub drum 2 in the main body 1, and the above-described air circulation path 72 is configured in the machine room 70.

An entrance 73 is formed at one end of the air circulation path 72, and an evaporator 24 of a refrigerant circuit 20 described later is placed in the air circulation path 72 in the vicinity of the entrance 73 of the air circulation path 72. Moreover, the entrance 73 of the air circulation path 72 is in communication with a rear part in the external tub drum 2. Further, an exit 74 is formed at the other end of the air circulation path 72, and a gas cooler 22 of the refrigerant circuit 20 described later is placed in the air circulation path 72 in the vicinity of the exit 74. The exit 74 of the air circulation path 72 is open at the hollow part 9 formed in the other end of the shaft 8.

Furthermore, an air blower 75 as air blowing means is provided in the air circulation path 72 and blows air from the exit 74 of the air circulation path 72 into the storage room 10 in the internal tub drum 5 through the hollow part 9 of the shaft 8. More specifically, in the washer drier 100, the air in the internal tub drum 5 is circulated in the air circulation path 72 by the air blower 75 during the drying operation, whereby the air is discharged into the storage room 10 in the internal tub drum 5 after the air is heated through heat exchange with the gas cooler 22 provided on the side of the exit 74 of the air circulation path 72. Further, the air which has circulated in the storage room 10 and dried the washing target is sucked into the air circulation path 72 from the entrance 73, cooled down through heat exchange with the evaporator 24 provided on the side of the entrance 73, sucked again by the air blower 75 to be sent to the gas cooler 22 after moisture is eliminated, and discharged into the storage room 10.

Next, 20 denotes the refrigerant circuit described above, and the refrigerant circuit 20 is configured by sequentially connecting, with a pipe in a circular form, a compressor 21, the gas cooler 22 as a radiator, an expansion valve 23 as a pressure reducing device, the evaporator 24 and the like. Further, a predetermined amount of carbon dioxide (CO₂) is sealed as the refrigerant in the refrigerant circuit 20. Here, the compressor 21 used in the present embodiment is an internal intermediate pressure type multistage compressing rotary compressor, and in an unshown airtight container, there are provided an electric operation element, and a first rotary compression-element (first stage) and a second rotary compression element (second stage) that are driven by the electric operation element.

Furthermore, a low-pressure refrigerant is introduced into the first rotary compression element of the compressor 21 from a refrigerant introducing pipe 30, and a high-temperature high-pressure refrigerant compressed by the second rotary compression element is discharged outside the compressor 21 from a refrigerant discharge pipe 32.

The refrigerant discharge pipe 32 of the compressor 21 is connected, via a three-way valve 93 described later, to an entrance of the gas cooler 22 for heating air provided on the side of the exit 74 of the air circulation path 72. The pipe coming out of the gas cooler 22 is connected to an entrance of the expansion valve 23 via a three-way valve 94. The pipe coming out of the expansion valve 23 reaches an entrance of the evaporator 24 provided on the side of the entrance 73, and the entrance of the evaporator 24 is connected to the refrigerant introducing pipe 30 and reaches the compressor 21. In addition, the operation of the compressor 21, and the expansion valve 23, and the three-way valves 93 and 94 are controlled by the controller 110.

In this case, a bypass circuit 90 running around the gas cooler 22 is formed in the refrigerant circuit 20, and an external radiator 91 is provided in the middle of the bypass circuit 90. This external radiator 91 is provided in, for example, the machine room 70 (place in communication with the outside) outside the air circulation path 72, and both ends of the bypass circuit 90 are connected to the three-way valves 93 and 94. Moreover, in the after-mentioned cooling operation after completion of the drying operation, the controller 110 switches the three-way valves 93 and 94 so as to cause the refrigerant discharged from the compressor 21 to run into the external radiator 91 and release heat without running into the gas cooler 22.

It is to be noted that the controller 110 described above is the control means for controlling the washer drier 100, and controls the operation of the drive motor M, opening and closing of the water supply valve 35 of the water supply passage 15, opening and closing of the water discharge valve 13 of the water discharge passage 12, operation of the compressor 21, adjustment of the expansion valve 23, an airflow amount of the air blower 75, and switching of the three-way valves 93 and 94. Further, the controller 110 also controls the temperature of the air that has passed through the gas cooler 22 so that the washing target stored in the internal tub drum 5 does not change color and is not damaged.

An operation of the washer drier 100 will next be described with the above configuration. When a washing target and a predetermined amount of detergent corresponding to the amount of the washing target are put into the storage room 10 in the internal tub drum 5 and a power switch and a start switch among the operation switches described above are operated, the controller 110 starts the washing operation. Then, the controller 110 opens the water supply valve 35 of the water supply passage 15 to open the water supply passage 15. Thereby, water is supplied from the water supply source into the storage room 10 of the internal tub drum 5 in the external tub drum 2. It is to be noted that the water discharge valve 13 of the water discharge passage 12 is closed by the controller 110 at this moment.

When a predetermined amount of hot water is collected in the storage room 10 in the internal tub drum 5, the controller 110 closes the water supply valve 35 to block the water supply passage 15. Thereby, the supply of water from the water supply source is stopped.

Next, the drive motor M formed on the side surface of the main body 1 is conducted and started by the controller 110 to rotate the shaft 8, and the internal tub drum 5 attached to the shaft 8 thus starts rotating in the external tub drum 2, thereby starting a washing process of the washing operation.

After a predetermined time has passed since the start of the washing process, the controller 110 stops the drive motor M, and the water discharge valve 13 of the water discharge passage 12 is opened to discharge the water (washing water) in the storage room 10 of the external tub drum 2 (i.e., in the internal tub drum 5).

Furthermore, when the water in the storage room 10 of the internal tub drum 5 is discharged, the controller 110 again actuates the drive motor M, and dewaters the washing target. After the dewatering is performed for a predetermined period of time, the controller 110 closes the water discharge valve 13 of the water discharge passage 12.

Next, the controller 110 moves to a rinse process, and opens the water supply valve 35 of the water supply passage 15 to open the water supply passage 15. Thereby, water is again supplied from the water supply source to the storage room 10 in the internal tub drum 5.

If a predetermined amount of water is supplied to the storage room 10 in the internal tub drum 5, the controller 110 closes the water supply valve 35 and blocks the water supply passage 15. Thereby, the supply of water from the water supply source is stopped.

Then, after rotating operation of the drive motor M is repeated for a predetermined period of time to achieve rinsing, the controller 110 stops the drive motor M, and opens the water discharge valve 13 of the water discharge passage 12 to discharge rinse water in the storage room 10 to the water discharge passage 12. When the rinse water in the storage room 10 is discharged, the controller 110 again actuates the drive motor M, and rotates the internal tub drum 5 in the same manner as described above and moves to the dewatering process to dewater the washing target.

Then, after the dewatering process is performed for a predetermined period of time, the controller 110 closes the water discharge valve 13. Moreover, the controller 110 switches the three-way valves 93 and 94 so that the refrigerant in the refrigerant circuit 20 runs not to the bypass circuit 90 but to the gas cooler 22 as indicated with arrows in FIG. 2, and starts the operation of the air blower 75 and also starts the electric operation element of the compressor 21. In this way, the refrigerant (CO₂) is sucked into the first rotary compression element of the compressor 21 and compressed. The refrigerant compressed to an intermediate pressure by the first rotary compression element is discharged into the airtight container, and the refrigerant discharged into the airtight container is sucked into the second rotary compression element and subjected to the second stage compression to become a high-temperature high-pressure refrigerant gas, and then discharged from the refrigerant discharge pipe 32 to the outside.

The refrigerant gas discharged from the refrigerant discharge pipe 32 flows into the gas cooler 22 through the three-way valve 93. Here, the high-temperature high-pressure refrigerant compressed by the compressor 21 is not condensed and is operated in a super critical state. Moreover, the refrigerant when flowing into the gas cooler 22 is increased to about +130° C., and the high-temperature high-pressure refrigerant gas releases heat in the gas cooler 22. The refrigerant coming out of the gas cooler 22 is pressure reduced by the expansion valve 23, and then runs into the evaporator 24 where the refrigerant absorbs heat from the ambience and is evaporated and then circulates by being sucked from the refrigerant introducing pipe 30 into first rotary compression element of the compressor 21.

Furthermore, the air which has reached a high temperature by being heated due to heat release of the high-temperature high-pressure refrigerant in the gas cooler 22 comes out from the exit 74 of the air circulation path 72 into the hollow part 9 and is discharged into the storage room 10 of the internal tub drum 5 by the operation of the air blower 75.

The heated air (+80° C. to +110° C. at this point) discharged into the storage room 10 warms up the washing target stored in the internal tub drum 5 (the storage room 10) and evaporates moisture therefrom, and thus dries the washing target. Air (air temperature is about +50° C. to +90° C.) which has dried the washing target and is charged with moisture comes out from the through-holes 7 to the outside of the internal tub drum 5 through the storage room 10, and is sucked from the entrance 73 into the air circulation path 72, and then passes through the evaporator 24 provided therein. The temperature of the evaporator 24 is decreased to about 0° C. to +30° C. by the evaporation of the refrigerant, so that the moisture in the air is condensed on a surface of the evaporator 24 while passing through the evaporator 24, and becomes water drops and falls. The fallen water drops are discharged from the water discharge passage 12 to the outside drain or the like via an unshown drain pipe.

Furthermore, the refrigerant coming out of the gas cooler 22 is pressure reduced by the expansion valve 23, and then runs into the evaporator 24 where the refrigerant absorbs heat from the ambience and is evaporated and then circulates by being sucked from the refrigerant discharge pipe 32 into first rotary compression element of the compressor 21.

Moreover, the air from which moisture has been eliminated and which has been dried by the evaporator 24 (temperature is reduced to about 0° C. to +45° C.) is sucked into the air blower 75, and is blown to the side of the exit 74 of the air circulation path 72. The gas cooler 22 is provided on the side of the exit 74 of the air circulation path 72 as described above, so that the dried air, after again heated by the gas cooler 22, is discharged into the storage room 10 in the internal tub drum 5 through the hollow part 9 of the shaft 8 and repeats circulation to remove moisture from and dry the washing target in the internal tub drum 5.

The controller 110 performs such a drying operation for a predetermined period of time, thereby completely drying the washing target in the storage room 10 in the internal tub drum 5.

After a predetermined time has passed since the start of the drying operation and the washing target is dried as described above, the controller 110 switches the three-way valves 93 and 94 so that the refrigerant in the refrigerant circuit 20 runs to the external radiator 91 of the bypass circuit 90 as indicated with arrows in FIG. 3, and moves to the cooling operation after completion of the drying operation to cool down the washing target. Thereby, the refrigerant discharged from the compressor 21 flows, without flowing into the gas cooler 22, into the external radiator 91 where the refrigerant releases heat and is pressure reduced by the expansion valve 23 before being evaporated by the evaporator 24.

In other words, as the refrigerant releases heat in the external radiator 91 provided outside the air circulation path 72 in the cooling operation, a heating function in the gas cooler 22 is stopped. Therefore, the air sent to the gas cooler 22 by the air blower 75 is discharged into the storage room 10 without being heated, and cooled down due to heat removal by the refrigerant in the evaporator 24, and then passes again through the air blower 75 and the gas cooler 22 to be discharged into the storage room 10.

In this way, the air which has been only cooled down by the evaporator 24 without being heated by the gas cooler 22 is circulated in the storage room 10 in the internal tub drum 5, and the temperature of the washing target is rapidly decreased. Thus, the cooling operation makes it possible to promptly lower the temperature of the washing target warmed up in the drying operation to a temperature at which the washing target can be taken out.

Here, the cooling operation as in the present invention has not heretofore been performed, and after the drying operation, the compressor 21 is stopped to operate only the air blower 75 or merely left unattended, so that a significant time has been required until the washing target can be taken out from the storage room 10.

However, the air from which moisture has been eliminated and which has been cooled down through the evaporator 24 is discharged into the storage room 10 by the cooling operation to allow a significant reduction in the cooling time. This makes it possible to improve operation efficiency of the washer drier 100.

Furthermore, as cool air from which moisture has been eliminated by the evaporator 24 is discharged into the storage room 10, it is possible to avoid such a disadvantage that the washing target once dried is again charged with moisture in the cooling operation.

### (2) Second Embodiment

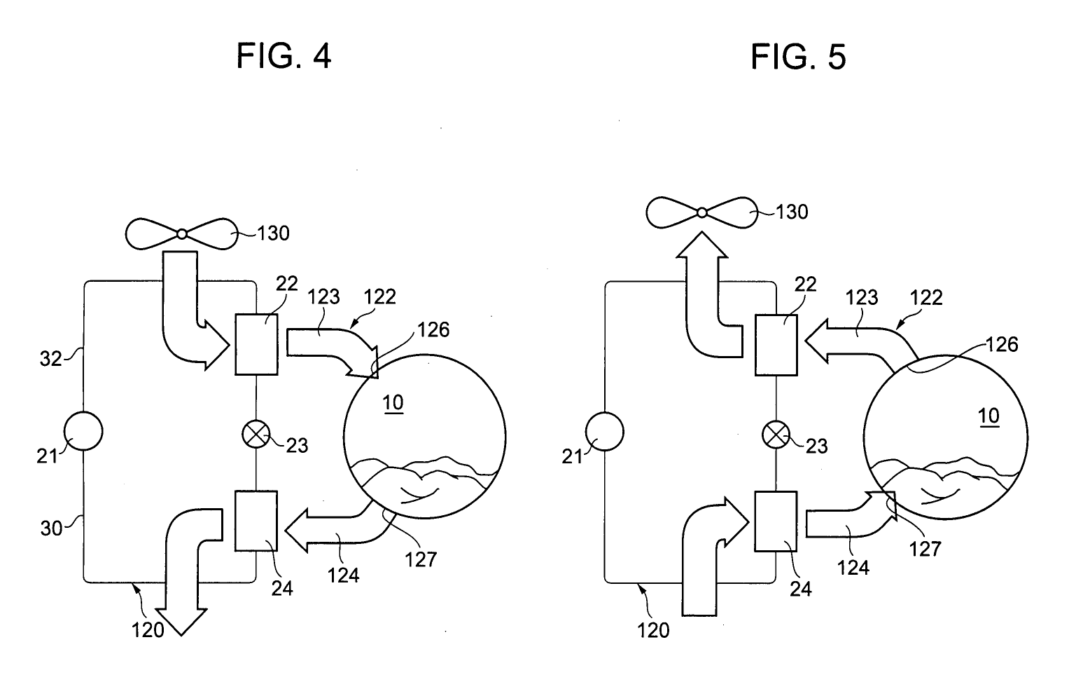

Next, a second embodiment of the dryer of the present invention will be described in detail referring to FIG. 4 and FIG. 5. FIG. 4 is a diagram showing the flow of the refrigerant and air in the drying operation of the washer drier 100 in this embodiment, and FIG. 5 is a diagram showing the flow of the refrigerant and air in the cooling operation after completion of the drying operation.

It is to be noted that in FIG. 4 and FIG. 5, those with the same numerals as in FIG. 1, FIG. 2 and FIG. 3 function in the same or similar manner. In FIG. 4, 120 denotes a refrigerant circuit, and the refrigerant circuit 120 is configured by sequentially connecting, with a pipe in a circular form, the compressor 21, the gas cooler 22 as the radiator, the expansion valve 23 as the pressure reducing device, the evaporator 24 and the like. Further, a predetermined amount of carbon dioxide (CO₂) is sealed as the refrigerant in the refrigerant circuit 120 similarly to the above-described embodiment.

On the other hand, in the washer drier 100, the machine room 70 is configured from the lower side and/or rear side to the lateral side of the external tub drum 2 in the main body 1, and an air path 122 is configured in the machine room 70.

The air path 122 is constituted of a heating side path 123 and a cooling side path 124. An opening 126 in communication with the hollow part 9 formed at the other end of the shaft 8 is formed at one end of the heating side path 123, and the gas cooler 22 of the refrigerant circuit 120 is placed in the heating side path 123 in the vicinity of the opening 126 of the heating side path 123. Moreover, the other end of the heating side path 123 is in communication with the outside of the washer drier 100.

Furthermore, an opening 127 in communication with the rear part in the external tub drum 2 is formed at one end of the cooling side path 124 of the air path 122, and the evaporator 24 of the refrigerant circuit 120 is placed in the cooling side path 124 in the vicinity of the opening 127 of the cooling side path 124. In addition, the other end of the cooling side path 124 is in communication with the outside of the washer drier 100.

Furthermore, an air blower 130 as the air blowing means for passing the air in the air path 122 to the gas cooler 22, into the storage room 10 provided in the internal tub drum 5, and to the evaporator 24 is provided in the heating side path 123 of the air path 122. The air blower 130 is capable of forward/backward rotations, and its airflow amount and rotating direction are controlled by the controller 110.

Furthermore, in the drying operation, under the control of the controller 110, air is sucked from the outside by the air blower 130, and the air is sent to the heating side path 123 for heat exchange with the gas cooler 22, and then the air is discharged into the storage room 10. The air which has passed through the storage room 10 is sent to the cooling side path 124 for heat exchange with the evaporator 24, and is then discharged to the outside. In the cooling operation, under the control of the controller 110, the rotating direction of the air blower 130 is inverted, and the air is sucked from the outside and sent to the cooling side path 124 for heat exchange with the evaporator 24, and then the air is discharged into the storage room 10. The air which has passed through the storage room 10 is sent to the heating side path 123 for heat exchange with the gas cooler 22, and is then discharged to the outside.

Next, the operation of the washer drier 100 in this case will be described. After the dewatering process is performed for a predetermined period of time as in the embodiment described above, if the controller 110 closes the water discharge valve 13, the controller 110 moves to the drying operation of the washing target. Further, the controller 110 starts the operation (forward rotation) of the air blower 130, and starts the electric operation element of the compressor 21. In this way, the refrigerant (CO₂) is compressed by the compressor 21, and is brought to a high temperature and a high pressure, and is then discharged from the refrigerant discharge pipe 32 to flow into the gas cooler 22.

Here, the high-temperature high-pressure refrigerant compressed by the compressor 21 is not condensed and is operated in a super critical state. Moreover, the refrigerant when flowing into the gas cooler 22 is increased to about +130° C., and the high-temperature high-pressure refrigerant gas releases heat in the gas cooler 22. The refrigerant coming out of the gas cooler 22 is pressure reduced by the expansion valve 23, and then runs into the evaporator 24 where the refrigerant absorbs heat from the ambience and is evaporated and then circulates by being sucked from the refrigerant discharge pipe 32 into first rotary compression element of the compressor 21.

On the other hand, the air introduced from the outside to the heating side path 123 of the air path 122 by the operation of the air blower 130 is heated and brought to a high temperature due to heat release of the high-temperature high-pressure refrigerant in the gas cooler 22, and comes out from the opening 126 of the heating side path 123 into the hollow part 9 to be discharged into the storage room 10 of the internal tub drum 5.

The heated air (+80° C. to +110° C. at this point) discharged into the storage room 10 warms up the washing target stored in the internal tub drum 5 (the storage room 10) and evaporates moisture therefrom, and thus dries the washing target. Air (air temperature is about +50° C. to +90° C.) which has dried the washing target and is charged with moisture comes out from the through-holes 7 to the outside of the internal tub drum 5 through the storage room 10, and is sucked from the opening 127 of the cooling side path 124 into the cooling side path 124 of the air path 122, and then passes through the evaporator 24 provided therein. The temperature of the evaporator 24 is decreased to about 0° C. to +30° C. by the evaporation of the refrigerant, so that the moisture in the air is condensed on the surface of the evaporator 24 while passing through the evaporator 24, and becomes water drops and falls. The fallen water drops are discharged from the water discharge passage 12 to the outside drain or the like via the unshown drain pipe.

Moreover, the air from which moisture has been eliminated and which has been dried by the evaporator 24 (temperature is reduced to about 0° C. to +45° C.) is discharged to the outside from the other end of the cooling side path 124.

The controller 110 performs such a drying operation for a predetermined period of time, thereby drying the washing target in the storage room 10 in the internal tub drum 5.

After a predetermined time has passed since the start of the drying operation and the washing target is dried as described above, the controller 110 reverses the rotation of the air blower 130, and moves to the cooling operation after completion of the drying operation to cool down the washing target. The reverse rotation of the air blower 130 introduces the air from the outside to the cooling side path 124 of the air path 122, and the air is cooled down due to heat absorption of the refrigerant in the evaporator 24 and the moisture contained therein is eliminated. Subsequently, the air is discharged from the opening 127 of the cooling side path 124 to the storage room 10 in the internal tub drum 5.

The cooled air discharged into the storage room 10 cools down the washing target stored in the internal tub drum 5 (the storage room 10), and then enters the heating side path 123 from the opening 126 of the heating side path 123. The gas cooler 22 provided in the heating side path 123 increases the temperature of the air, and the air is sucked into the air blower 130 and discharged to the outside.

In this way, the air cooled down by the evaporator 24 is discharged into the storage room 10 in the cooling operation, and the air is not heated by the gas cooler 22, so that the cooling operation makes it possible to promptly lower the temperature of the washing target warmed up in the drying operation as in the embodiment described above.

Especially, in this case, the embodiment can be achieved only by operation control of the air blower 130 without providing the three-way valves or the like of the radiator and the refrigerant circuit as in the above-described embodiment, thus also enabling production costs to be reduced.

In addition, the air in the air path 122 is sucked from the outside and discharged outside by the air blower 130 in this embodiment, but this is not a limitation. As in the above-described embodiment, it is possible to apply such a method that in the drying operation, air is circulated from the gas cooler 22 to the storage room 10, from the storage room 10 to the evaporator 24, and from the evaporator 24 to the gas cooler 22, while in the cooling operation, air is circulated from the evaporator 24 to the storage room 10, from the storage room 10 to the gas cooler 22, and from the gas cooler 22 to the evaporator 24.

### (3) Third Embodiment

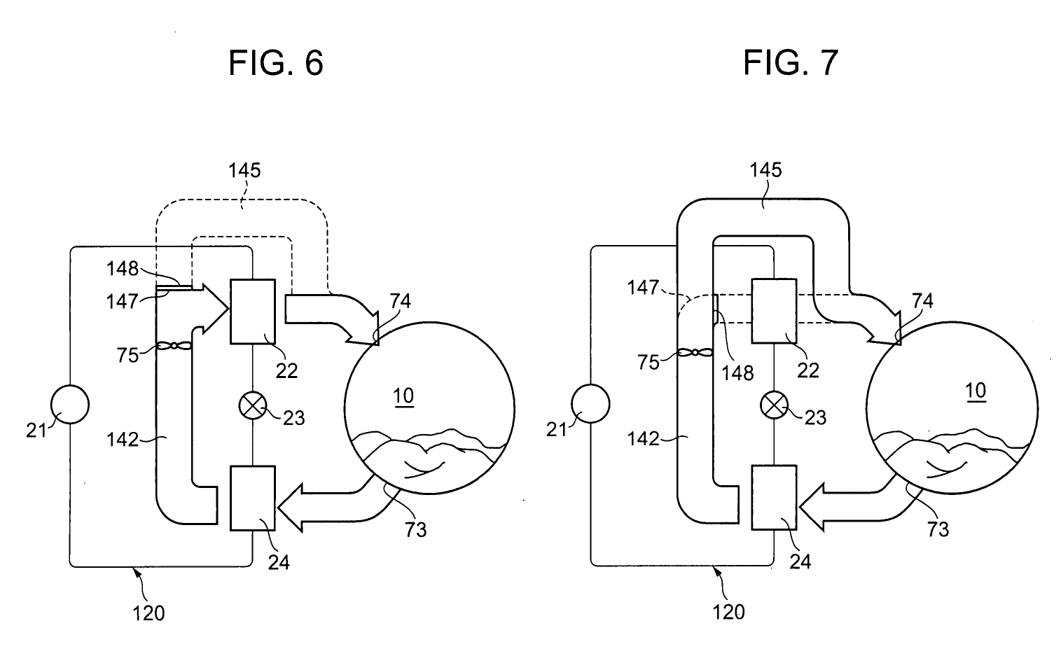

Next, a third embodiment of the dryer of the present invention will be described in detail referring to FIG. 6 and FIG. 7. FIG. 6 is a diagram showing the flow of the refrigerant and air in the drying operation of the washer drier 100 in this embodiment, and FIG. 7 is a diagram showing the flow of the refrigerant and air in the cooling operation after completion of the drying operation.

It is to be noted that those with the same numerals in FIG. 6 and FIG. 7 as in the drawings mention above function in the same or similar manner. In FIG. 6, 120 denotes a refrigerant circuit, and the refrigerant circuit 120 is configured by sequentially connecting, with a pipe in a circular form, the compressor 21, the gas cooler 22 as the radiator, the expansion valve 23 as the pressure reducing device, the evaporator 24 and the like. Further, a predetermined amount of carbon dioxide (CO₂) is sealed as the refrigerant in the refrigerant circuit 120 similarly to the above-described embodiments.

On the other hand, in the washer drier 100, the machine room 70 is configured from the lower side and/or rear side to the lateral side of the external tub drum 2 in the main body 1, and an air circulation path 142 is configured in the machine room 70. This air circulation path 142 is a path for circulating air from the evaporator 24 into the storage room 10 through the gas cooler 22.

The entrance 73 is formed at one end of the air circulation path 142, and the evaporator 24 of the refrigerant circuit 120 is placed in the air circulation path 142 in the vicinity of the entrance 73 of the air circulation path 142. Moreover, the entrance 73 of the air circulation path 142 is in communication with the rear part in the external tub drum 2. Further, the exit 74 is formed at the other end of the air circulation path 142, and the gas cooler 22 of the refrigerant circuit 120 is placed in the air circulation path 142 in the vicinity of the exit 74 thereof. The exit 74 of the air circulation path 142 is open at the hollow part 9 formed in the other end of the shaft 8.

On the other hand, a bypass channel 145 for circulating air around the gas cooler 22 is formed in the air circulation path 142. On the side of an entrance 147 of the bypass channel 145, a damper 148 is provided as a switch device for adjusting the inflow of air circulated by the air blower 75. Further, the controller 110, in the drying operation, closes the entrance 147 of the bypass channel 145 to block the bypass channel 145, while in the cooling operation, the controller 110 closes the air circulation path 142, and controls the damper 148 so that air does not flow to the gas cooler 22.

In other words, the controller 110 controls the damper 148 so that in the drying operation, air is circulated through the air circulation path 142 by the air blower 75, while in the cooling operation, air is circulated from the evaporator 24 into the storage room 10 via the bypass channel 145 by the air blower 75.

Next, the operation of the washer drier 100 in this case will be described. After the dewatering process is performed for a predetermined period of time as in the embodiments described above, if the controller 110 closes the water discharge valve 13, the controller 110 moves to the drying operation of the washing target. Further, the controller 110 switches the damper 148 (blocks the bypass channel 145 with the damper 148 as shown in FIG. 6) so that the air in the air circulation path 142 runs to the gas cooler 22. Further, the controller 110 starts the operation of the air blower 75 and also starts the electric operation element of the compressor 21. In this way, the refrigerant (CO₂) is compressed by the compressor 21, and is brought to a high temperature and a high pressure, and is then discharged from the refrigerant discharge pipe 32 to flow into the gas cooler 22. Here, the high-temperature high-pressure refrigerant compressed by the compressor 21 is not condensed and is operated in a super critical state. Moreover, the refrigerant when flowing into the gas cooler 22 is increased to about +130° C., and the high-temperature high-pressure refrigerant gas releases heat in the gas cooler 22. The refrigerant coming out of the gas cooler 22 is pressure reduced by the expansion valve 23, and then runs into the evaporator 24 where the refrigerant absorbs heat from the ambience and is evaporated and then circulates by being sucked from the refrigerant discharge pipe 32 into first rotary compression element of the compressor 21.

On the other hand, the air heated to a high temperature due to heat release of the high-temperature high-pressure refrigerant in the gas cooler 22 of the air circulation path 142 comes out from the exit 74 of the air circulation path 142 into the hollow part 9 and is discharged into the storage room 10 of the internal tub drum 5.

The heated air discharged into the storage room 10 warms up the washing target stored in the internal tub drum 5 (the storage room 10) and evaporates moisture therefrom, and thus dries the washing target. The air which has dried the washing target and is charged with moisture comes out from the through-holes to the outside of the internal tub drum 5 through the storage room 10, and is sucked from the entrance 73 into the air circulation path 142, and then passes through the evaporator 24 provided therein. The moisture in the air is condensed on the surface of the evaporator 24 while passing through the evaporator 24, and becomes water drops and falls. The fallen water drops are discharged from the water discharge passage 12 to the outside drain or the like via the unshown drain pipe.

Moreover, the air from which moisture has been eliminated and which has been dried by the evaporator 24 is sucked into of the air blower 75, and is blown to the side of the exit 74 of the air circulation path 142. The gas cooler 22 is provided on the side of the exit 74 of the air circulation path 142 as described above, so that the dried air, after again heated by the gas cooler 22, is discharged into the storage room 10 in the internal tub drum 5 through the hollow part 9 of the shaft 8 and repeats circulation to remove moisture from and dry the washing target in the internal tub drum 5.

The controller 110 performs such a drying operation for a predetermined period of time, thereby drying the washing target in the storage room 10 in the internal tub drum 5.

After a predetermined time has passed since the start of the drying operation and the washing target is dried as described above, the controller 110 blocks the air circulation path 142 with the damper 148 so that the air from the evaporator 24 flows to the bypass channel 145 (FIG. 7), and moves to the cooling operation after completion of the drying operation to cool down the washing target. In this way, the air from the evaporator 24 all flows to the bypass channel 145.

Therefore, the cooled air from which heat is removed by the refrigerant in the evaporator 24 is discharged into the storage room 10 without being heated in the gas cooler 22. The cooled air discharged into the storage room 10 cools down the washing target stored in the internal tub drum 5 (the storage room 10).

Thus, the cooling operation makes it possible to promptly cool down the washing target warmed up in the drying operation to a temperature at which the washing target can be taken out, as in the embodiment described above.

Subsequently, the air which has cooled down the washing target in the storage room 10 repeats circulation of being sucked from the entrance 73 to enter the air circulation path 142, releasing heat through heat removal by the refrigerant while passing through the evaporator 24, being discharged from the exit 74 into the storage room 10 through the bypass channel 145, and cooling down the washing target stored in the internal tub drum 5.

### (4) Fourth Embodiment

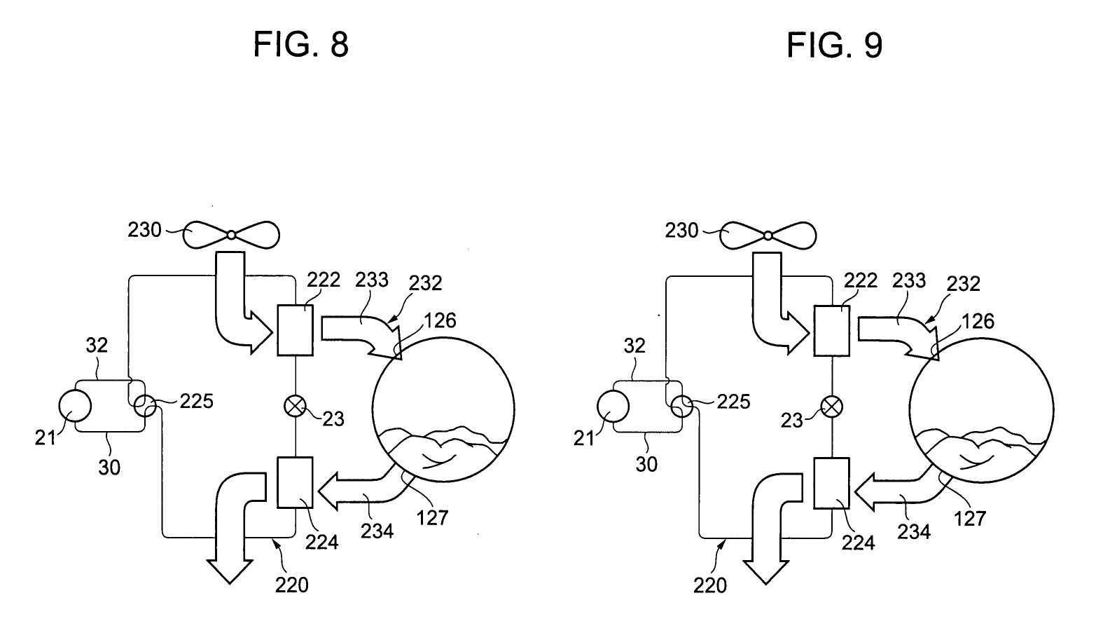

Next, a fourth embodiment of the drier of the present invention will be described in detail referring to FIG. 8 and FIG. 9. FIG. 8 is a diagram showing the flow of the refrigerant and air in the drying operation of the washer drier 100 in this case, and FIG. 9 is a diagram showing the flow of the refrigerant and air in the cooling operation after completion of the drying operation.

It is to be noted that those with the same numerals in FIG. 8 and FIG. 9 as in the drawings mention above function in the same or similar manner. In FIG. 8, 220 denotes a reversible refrigerant circuit, and the refrigerant circuit 220 is constituted of the compressor 21, a first heat exchanger 222, the expansion valve 23 as the pressure reducing device, a second heat exchanger 224 and the like. Further, a predetermined amount of carbon dioxide (CO₂) is sealed as the refrigerant in the refrigerant circuit 220 as described above.

Here, a four-way valve 225 is provided in the refrigerant circuit 220. In other words, the refrigerant discharge pipe 32 of the compressor 21 is connected with a pipe to the first heat exchanger 222 via the four-way valve 225, and the first heat exchanger 222 is connected to the second heat exchanger 224 via the expansion valve 23. Further, the second heat exchanger 224 is connected to the refrigerant introducing pipe 30 via the four-way valve 225.

The four-way valve 225 is controlled by the controller 110, and the controller 110 switches the four-way valve 225 so that in the drying operation, the refrigerant discharged from the compressor 21 flows through the first heat exchanger 222 to release heat, and is pressure reduced by the expansion valve 23, and is then evaporated by the second heat exchanger 224, while in the cooling operation, the refrigerant discharged from the compressor 21 flows through the second heat exchanger 224 to release heat, and is pressure reduced by the expansion valve 23, and is then evaporated by the first heat exchanger 222.

On the other hand, in the washer drier 100, the machine room 70 is configured from the lower side and/or rear side to the lateral side of the external tub drum 2 in the main body 1, and an air path 232 is configured in the machine room 70.

The air path 232 is constituted of a first path 233 and a second path 124. The opening 126 in communication with the hollow part 9 formed at the other end of the shaft 8 is formed at one end of the first path 233, and the first heat exchanger 222 of the refrigerant circuit 220 is placed in the first path 233 in the vicinity of the opening 126 of the first path 233. Moreover, the other end of the first path 233 is in communication with the outside of the washer drier 100.

Furthermore, the opening 127 in communication with the rear part in the external tub drum 2 is formed at one end of the second path 234 of the air path 232, and the second heat exchanger 224 of the refrigerant circuit 220 is placed in the second path 234 in the vicinity of the opening 127 of the second path 234. In addition, the other end of the second path 234 is in communication with the outside of the washer drier 110.

Furthermore, an air blower 230 as the air blowing means for passing air in the air path 222 to the first heat exchanger 222, into the storage room 10 provided in the internal tub drum 5, and to the second heat exchanger 224 is provided in the first path 223 of the air path 232.

Next, the operation of the washer drier 100 in this case will be described. After the dewatering process is performed for a predetermined period of time as in the embodiments described above, if the controller 110 closes the water discharge valve 13, the controller 110 moves to the drying operation of the washing target. Further, the controller 110 switches the four-way valve 225 as shown in FIG. 8 so that the refrigerant from the compressor 21 runs to the first heat exchanger 222. Subsequently, the controller 110 starts the electric operation element of the compressor 21 and also starts the operation of the air blower 230.

In this way, the refrigerant (CO₂) is sucked into the first rotary compression element of the compressor 21 and compressed. The refrigerant compressed to an intermediate pressure by the first rotary compression element is discharged into the airtight container, and the refrigerant discharged into the airtight container is sucked into the second rotary compression element and subjected to the second stage compression to become a high-temperature high-pressure refrigerant gas, and then discharged from the refrigerant discharge pipe 32 to the outside.

The refrigerant gas discharged from the refrigerant discharge pipe 32 flows into the first heat exchanger 222 through the four-way valve 225. Here, the high-temperature high-pressure refrigerant compressed by the compressor 21 is not condensed and is operated in a super critical state. Moreover, the refrigerant when flowing into the first heat exchanger 222 is increased to about +130° C., and the high-temperature high-pressure refrigerant gas releases heat in the first heat exchanger 222. The refrigerant coming out of the first heat exchanger 222 is pressure reduced by the expansion valve 23, and then runs into the second heat exchanger 224 where the refrigerant absorbs heat from the ambience and is evaporated and then circulates by being sucked from the refrigerant discharge pipe 32 into first rotary compression element of the compressor 21 through the four-way valve 225.

Furthermore, the air introduced from the outside to the first path 233 of the air path 232 by the operation of the air blower 230 is heated to a high temperature due to heat release of the high-temperature high-pressure refrigerant in the first heat exchanger 222, and comes out from the opening 126 of the first path 233 of the air path 232 into the hollow part 9 to be discharged into the storage room 10 of the internal tub drum 5.

The heated air (+80° C. to +110° C. at this point) discharged into the storage room 10 warms up the washing target stored in the internal tub drum 5 (the storage room 10) and evaporates moisture therefrom, and thus dries the washing target. Air (air temperature is about +50° C. to +90° C.) which has dried the washing target and is charged with moisture comes out from the through-holes 7 to the outside of the internal tub drum 5 through the storage room 10, and is sucked from the opening 127 of the second path 234 into the second path 234 of the air path 232, and then passes through the second heat exchanger 224 provided therein. The temperature of the second heat exchanger 224 is decreased to about 0° C. to +30° C. by the evaporation of the refrigerant, so that the moisture in the air is condensed on the surface of the second heat exchanger 224 while passing through the second heat exchanger 224, and becomes water drops and falls. The fallen water drops are discharged from the water discharge passage 12 to the outside drain or the like via the unshown drain pipe.

Moreover, the air from which moisture has been eliminated and which has been dried by the second heat exchanger 224 (temperature is reduced to about 0° C. to +45° C.) is discharged to the outside from the other end of the second path 234.

The controller 110 performs such a drying operation for a predetermined period of time, thereby drying the washing target in the storage room 10 in the internal tub drum 5.

After a predetermined time has passed since the start of the drying operation and the washing target is dried as described above, the controller 110 switches the four-way valve 225 as shown in FIG. 9 so that the refrigerant from the compressor 21 runs to the second heat exchanger 224. Thereby, the refrigerant gas discharged from the refrigerant discharge pipe 32 of the compressor 21 flows into the second heat exchanger 224 via the four-way valve 225 where the refrigerant gas releases heat. The refrigerant coming out of the second heat exchanger 224 is pressure reduced by the expansion valve 23, and flows into the first heat exchanger 222 where the refrigerant absorbs heat from the ambience and is evaporated and then circulates by being sucked from the refrigerant introducing pipe 30 into first rotary compression element of the compressor 21 through the four-way valve 225.

Furthermore, the air introduced from the outside to the first path 233 of the air path 232 by the operation of the air blower 230.is cooled down due to heat removal by the refrigerant in the first heat exchanger 222, and comes out from the opening 126 of the first path 233 of the air path 232 into the hollow part 9 to be discharged into the storage room 10 of the internal tub drum 5.

The cooled air discharged into the storage room 10 cools down the washing target stored in the internal tub drum 5 (the storage room 10), and then enters the second path 234 from the opening 127 of the second path 234, and then discharged to the outside after heated by the second heat exchanger 224 provided in the second path 234.

Thus, as in the embodiments described above, the cooling operation makes it possible to promptly cool down the washing target warmed up in the drying operation to a temperature at which the washing target can be taken out, allowing a significant reduction in the cooling time. This enables improvement in the operation efficiency of the washer drier 100.

In addition, the air in the air path 232 is sucked from the outside and discharged outside by the air blower 230 in this embodiment, but this is not a limitation. As in the above-described embodiment, it is possible to apply a method in which the air is sent from the second heat exchanger 224 to the first heat exchanger 222 and circulated again into the second heat exchanger 224 through the storage room 10.

Furthermore, the compressor 21 used in the embodiments described above is the internal intermediate pressure type multistage (two-stage) compressing rotary compressor comprising the first and second rotary compression elements, but the compressor 21 that can be used in the present invention is not limited thereto.

Still further, carbon dioxide (CO₂) is used as the refrigerant, and the operation is performed with a high-pressure side as a supercritical pressure in the embodiments described above, but the refrigerant that can be used for the dryer of the present invention is not limited thereto, and an HFC (hydrofluorocarbon) based refrigerant or the like is also effectively used.

As described above in detail, a dryer of the present invention comprises a storage room to accommodate a drying target and performs a drying operation and a cooling operation after completion of the drying operation for the drying target in the storage room, and the dryer comprises: a refrigerant circuit configured by sequentially connecting, with a pipe in a circular form, a compressor, a radiator, a pressure reducing device, an evaporator and the like; an air circulation path for circulating, by air blowing means, air from the radiator into the evaporator through the storage room; and an external radiator provided outside the air circulation path. In the drying operation, a refrigerant discharged from the compressor flows to the radiator to release heat, and is pressure reduced by the pressure reducing device, and is then evaporated by the evaporator. In the cooling operation, the refrigerant discharged from the compressor flows to the external radiator to release heat, and is pressure reduced by the pressure reducing device, and is then evaporated by the evaporator. Thus, in the drying operation, after the air is heated by the radiator, the air is discharged into the storage room to remove moisture from the drying target, and then the moisture removed by the evaporator is condensed, thereby enabling the drying target to be rapidly dried. In the cooling operation after completion of the drying operation, heating function in the radiator is stopped, and the air only cooled down by the evaporator can be discharged into the storage room.

This promotes the cooling of the drying target in the storage room after completion of the drying operation, and makes it possible to significantly reduce the time to be decreased to the temperature at which the drying target can be taken out.

Furthermore, a dryer of the present invention comprises a storage room to accommodate a drying target and performs a drying operation and a cooling operation after completion of the drying operation for the drying target in the storage room. The dryer comprises: a refrigerant circuit configured by sequentially connecting, with a pipe in a circular form, a compressor, a radiator, a pressure reducing device and an evaporator; and air blowing means for passing air to the radiator, into the storage room, and to the evaporator. In the drying operation, by the air blowing means, the air exchanges heat with the radiator and is then discharged into the storage room, and the air which has passed through the storage room exchanges heat with the evaporator. In the cooling operation, by the air blowing means, the air exchanges heat with the evaporator and is then discharged into the storage room, and the air which has passed through the storage room exchanges heat with the radiator. Thus, in the drying operation, after the air is heated by the radiator, the air is discharged into the storage room to remove moisture from the drying target, and then the moisture removed by the evaporator is condensed, thereby enabling the drying target to be rapidly dried. In the cooling operation after completion of the drying operation, the air cooled down by the evaporator can be discharged into the storage room.

This promotes the cooling of the drying target in the storage room after completion of the drying operation, and makes it possible to significantly reduce the time to be decreased to the temperature at which the drying target can be taken out. Especially, in this case, no specific external radiator and configuration are needed, so that costs can also be prevented from increasing.

Furthermore, a dryer of the present invention comprises a storage room to accommodate a drying target and performs a drying operation and a cooling operation after completion of the drying operation for the drying target in the storage room. The dryer comprises: a refrigerant circuit configured by sequentially connecting, with a pipe in a circular form, a compressor, a radiator, a pressure reducing device and an evaporator; an air circulation path for circulating air from the evaporator into the storage room through the radiator by air blowing means; and a bypass channel for circulating the air around the radiator. In the drying operation, the air is circulated through the air circulation path by the air blowing means, and in the cooling operation, the air is circulated from the evaporator into the storage room through the bypass channel by the air blowing means. Thus, in the drying operation, after the air is heated by the radiator, the air is discharged into the storage room to remove moisture from the drying target, and then the moisture removed by the evaporator is condensed, thereby enabling the drying target to be rapidly dried. In the cooling operation after completion of the drying operation, the air is circulated around the radiator through the bypass channel, and the air only cooled down by the evaporator can be discharged into the storage room.

This promotes the cooling of the drying target in the storage room after completion of the drying operation, and makes it possible to significantly reduce the time to be decreased to the temperature at which the drying target can be taken out.

Furthermore, a dryer of the present invention comprises a storage room to accommodate a drying target and performs a drying operation and a cooling operation after completion of the drying operation for the drying target in the storage room. The dryer comprises: a reversible refrigerant circuit constituted of a compressor, a first heat exchanger, a pressure reducing device, a second heat exchanger and the like; and air blowing means for causing air to exchange heat with the first heat exchanger and then to be discharged into the storage room, and causing the air which has passed through the storage room to exchange heat with the second heat exchanger. In the drying operation, a refrigerant discharged from the compressor flows to the first heat exchanger to release heat, and is pressure reduced by the pressure reducing device, and is then evaporated by the second heat exchanger. In the cooling operation, the refrigerant discharged from the compressor flows to the second heat exchanger to release heat, and is pressure reduced by the pressure reducing device, and is then evaporated by the first heat exchanger. Thus, in the drying operation, after the first heat exchanger exerts heating function to heat the air, the air is discharged into the storage room to remove moisture from the drying target, and then the second heat exchanger exerts cooling function to condense the removed moisture, thereby enabling the drying target to be rapidly dried. In the cooling operation after completion of the drying operation, the first heat exchanger exerts the cooling function, and the air cooled down by the first heat exchanger can be discharged into the storage room.

This promotes the cooling of the drying target in the storage room after completion of the drying operation, and makes it possible to significantly reduce the time to be decreased to the temperature at which the drying target can be taken out. Especially, in this case, no specific external radiator and configuration are needed, so that costs can also be prevented from increasing.

1. A dryer which comprises a storage room to accommodate a drying target and which performs a drying operation and a cooling operation after completion of the drying operation for the drying target in the storage room, the dryer comprising:
a refrigerant circuit configured by sequentially connecting, with a pipe in a circular form, a compressor, a radiator, a pressure reducing device, an evaporator and the like;
an air circulation path for circulating, by air blowing means, air from the radiator into the evaporator through the storage room; and
an external radiator provided outside the air circulation path,
wherein in the drying operation, refrigerant discharged from the compressor flows to the radiator to release heat, and is pressure reduced by the pressure reducing device, and is then evaporated by the evaporator, and
in the cooling operation, the refrigerant discharged from the compressor flows to the external radiator to release heat, and is pressure reduced by the pressure reducing device, and is then evaporated by the evaporator.

2. A dryer which comprises a storage room to accommodate a drying target and which performs a drying operation and a cooling operation after completion of the drying operation for the drying target in the storage room, the dryer comprising:
a refrigerant circuit configured by sequentially connecting, with a pipe in a circular form, a compressor, a radiator, a pressure reducing device and an evaporator; and
air blowing means for passing air to the radiator, into the storage room, and to the evaporator,
wherein in the drying operation, by the air blowing means, the air exchanges heat with the radiator and is then discharged into the storage room, and the air which has passed through the storage room exchanges heat with the evaporator, and
in the cooling operation, by the air blowing means, the air exchanges heat with the evaporator and is then discharged into the storage room, and the air which has passed through the storage room exchanges heat with the radiator.

3. A dryer which comprises a storage room to accommodate a drying target and which performs a drying operation and a cooling operation after completion of the drying operation for the drying target in the storage room, the dryer comprising:
a refrigerant circuit configured by sequentially connecting, with a pipe in a circular form, a compressor, a radiator, a pressure reducing device and an evaporator;
an air circulation path for circulating air from the evaporator into the storage room through the radiator by air blowing means; and
a bypass channel for circulating the air around the radiator,
wherein in the drying operation, the air is circulated through the air circulation path by the air blowing means, and
in the cooling operation, the air is circulated from the evaporator into the storage room through the bypass channel by the air blowing means.

4. A dryer which comprises a storage room to accommodate a drying target and which performs a drying operation and a cooling operation after completion of the drying operation for the drying target in the storage room, the dryer comprising:
a reversible refrigerant circuit constituted of a compressor, a first heat exchanger, a pressure reducing device, a second heat exchanger and the like; and
air blowing means for causing air to exchange heat with the first heat exchanger and then to be discharged into the storage room, and causing the air which has passed through the storage room to exchange heat with the second heat exchanger,
wherein in the drying operation, refrigerant discharged from the compressor flows to the first heat exchanger to release heat, and is pressure reduced by the pressure reducing device, and is then evaporated by the second heat exchanger, and
in the cooling operation, the refrigerant discharged from the compressor flows to the second heat exchanger to release heat, and is pressure reduced by the pressure reducing device, and is then evaporated by the first heat exchanger.
